(19) United States
(12) Patent Application Publication
(10) Pub. No.: US 2025/0050896 A1
(43) Pub. Date: Feb. 13, 2025

(54) NAVIGATION INTERFACE PROMPT METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventor: Jingbo FAN, Shenzhen (CN)

(21) Appl. No.: 18/808,051

(22) Filed: Aug. 18, 2024

Related U.S. Application Data
(63) Continuation of application No. PCT/CN2023/090673, filed on Apr. 25, 2023.

(30) Foreign Application Priority Data
Aug. 1, 2022 (CN) 202210917366.X

(51) Int. Cl. B60W 50/08; B60W 30/182; B60W 50/14; B60W 60/00; G01C 21/00; G01C 21/34

(52) U.S. Cl. CPC B60W 50/082; B60W 30/182; B60W 50/14; B60W 60/005; G01C 21/3484; G01C 21/3811; B60W 2050/146

(57) ABSTRACT

A navigation interface prompt method, performed by a terminal, includes: displaying a dynamic location identifier corresponding to a vehicle in an electronic map in a navigation interface, the dynamic location identifier being configured for indicating a real-time location of the vehicle on a navigation route, and the vehicle being in a first driving mode; and displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

### CROSS-REFERENCES TO RELATED APPLICATIONS

This application is a continuation application of PCT Patent Application No. PCT/CN2023/090673, filed on Apr. 25, 2023, which claims priority to Chinese Patent Application No. 202210917366.X, filed on Aug. 1, 2022, all of which is incorporated by reference in their entirety.

### FIELD OF THE TECHNOLOGY

Embodiments of the present disclosure relate to the field of vehicle-to-everything technologies and, in particular, to a navigation interface prompt method and apparatus, a device, a storage medium, and a program product.

### BACKGROUND OF THE DISCLOSURE

At present, online navigation functions are widely used. For example, online car-hailing application software, navigation application software, and map application software may all need to provide vehicle traveling navigation functions.

A terminal displays a map within a specific range around a user in a navigation interface, indicates a current location of a vehicle driven by the user through a vehicle identifier, controls the vehicle identifier to move in the map of the navigation interface based on a location change of the vehicle, and reflects a traveling route of the vehicle in real time.

For an autonomous driving vehicle, it often requires driving mode switch from an autonomous driving mode to a manual driving mode, especially when the vehicle encounters unpredictable situations during traveling, such as dense traffic, road maintenance, and an object dropped on a road. Accordingly, prompt information “about to exit autonomous driving, please take control of the vehicle immediately” is displayed in the navigation interface. The driver may subconsciously take control of the vehicle immediately after seeing the prompt information, and the driver rushing to take control of the vehicle may easily cause driving safety hazards.

### SUMMARY

One embodiment of the present disclosure provides a navigation interface prompt method performed by a terminal. The method includes displaying a dynamic location identifier corresponding to a vehicle in an electronic map in a navigation interface, the dynamic location identifier being configured for indicating a real-time location of the vehicle on a navigation route, and the vehicle being in a first driving mode; and displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

Another embodiment of the present disclosure provides a computer device. The computer device includes one or more processors and a memory, the memory containing at least one computer program that, when being executed, causes the one or more processors to perform operations including displaying a dynamic location identifier corresponding to a vehicle in an electronic map in a navigation interface, the dynamic location identifier being configured for indicating a real-time location of the vehicle on a navigation route, and the vehicle being in a first driving mode; and displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

Another embodiment of the present disclosure provides a non-transitory computer-readable storage medium storing a computer-executable instruction that, when being executed, causes one or more processors to perform an information processing method. The method includes displaying a dynamic location identifier corresponding to a vehicle in an electronic map in a navigation interface, the dynamic location identifier being configured for indicating a real-time location of the vehicle on a navigation route, and the vehicle being in a first driving mode; and displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

### BRIEF DESCRIPTION OF THE DRAWINGS

FIG. 1 is a schematic diagram of a navigation interface prompt method according to an exemplary embodiment of the present disclosure.

FIG. 2 is a schematic diagram of an architecture of a computer system according to an exemplary embodiment of the present disclosure.

FIG. 3 is a flowchart of a navigation interface prompt method according to an exemplary embodiment of the present disclosure.

FIG. 4 is a flowchart of a navigation interface prompt method according to an exemplary embodiment of the present disclosure.

FIG. 5 is a schematic diagram of a navigation interface prompt method according to an exemplary embodiment of the present disclosure.

FIG. 6 is a schematic diagram of a navigation interface prompt method according to an exemplary embodiment of the present disclosure.

FIG. 7 is a schematic diagram of a navigation interface prompt method according to an exemplary embodiment of the present disclosure.

FIG. 8 is a schematic diagram of a navigation interface prompt method according to an exemplary embodiment of the present disclosure.

FIG. 9 is a flowchart of a method for indicating a driving mode change according to an exemplary embodiment of the present disclosure.

FIG. 10 is a flowchart of a method for indicating a driving mode change according to an exemplary embodiment of the present disclosure.

FIG. 11 is a flowchart of a navigation interface prompt method according to an exemplary embodiment of the present disclosure.

FIG. 12 is a block diagram of a navigation interface prompt apparatus according to an exemplary embodiment of the present disclosure.

FIG. 13 is a block diagram of an apparatus for indicating a driving mode change according to an exemplary embodiment of the present disclosure.

FIG. 14 is a schematic diagram of a structure of a computer device according to an exemplary embodiment of the present disclosure.

### DESCRIPTION OF EMBODIMENTS

The present disclosure discloses a navigation interface prompt method and apparatus, a device, a storage medium, and a program product, and relates to the field of vehicle-to-everything technologies. The method in the present disclosure is applicable to the field of autonomous driving, and the method includes: displaying a dynamic location identifier corresponding to a vehicle in an electronic map in a navigation interface, the current vehicle being in a first driving mode; and displaying, at a pre-prompt stage before the vehicle exits the first driving mode, a switch location identifier on the navigation route, the switch location identifier being configured for indicating a predicted location at which the current vehicle exits the first driving mode and switches to a second driving mode. According to the foregoing method, displaying a switch location identifier on a navigation route in a navigation interface allows a driver to clearly know driving mode switch time of a current vehicle, so that dangers caused by unpredictable situations such as driving mode switch during traveling of the current vehicle can be effectively avoid, thereby improving vehicle driving safety.

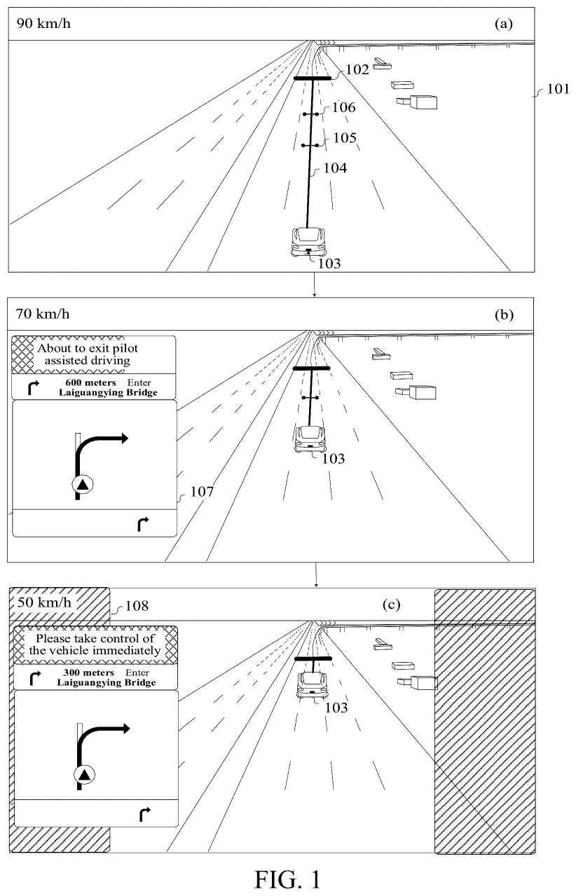

An embodiment of the present disclosure provides a schematic diagram of a navigation interface prompt method, as shown in FIG. 1. The method may be performed by a computer device, and the computer device may be a terminal or a server.

For example, a dynamic location identifier 103 corresponding to a vehicle is displayed in an electronic map in a navigation interface 101. The computer device displays, at a pre-prompt stage before the vehicle exits a first driving mode, a switch location identifier 102 on a navigation route.

The dynamic location identifier 103 is configured for indicating a real-time location of the vehicle on the navigation route, and the current vehicle is in the first driving mode. The switch location identifier 102 is configured for indicating a predicted location at which the current vehicle exits the first driving mode and switches to a second driving mode. The pre-prompt stage is a stage before the vehicle exits the first driving mode.

In some embodiments, the pre-prompt stage is a stage corresponding to a time threshold before the vehicle exits the first driving mode. For example, the vehicle exits the first driving mode after three minutes, and the three-minute stage is the pre-prompt stage. Alternatively, the pre-prompt stage is a stage corresponding to a distance threshold before the vehicle exits the first driving mode. For example, the vehicle exits the first driving mode after traveling one kilometer, and the one-kilometer stage is the pre-prompt stage. The pre-prompt stage is not limited thereto and is not specifically limited in embodiments of the present disclosure.

In some embodiments, the switch location identifier 102 is at least one of a boundary line, an X identifier, or an identifier with X superimposed on AUTO, but is not limited thereto. A form of the switch location identifier 102 is not specifically limited in embodiments of the present disclosure.

In some embodiments, the first driving mode is an autonomous driving mode or an assisted driving mode, and the second driving mode is a manual driving mode; the first driving mode is a fuel-powered driving mode or a fuel-gas-powered driving mode, and the second driving mode is an electric driving mode; the first driving mode is a fuel-powered driving mode, and the second driving mode is a fuel-gas-powered driving mode; or the first driving mode is a sport mode, and the second driving mode is a snow mode. The first driving mode and the second driving mode are not limited thereto and are not specifically limited in embodiments of the present disclosure.

The foregoing examples of the first driving mode and the second driving mode may be switched between the first driving mode and the second driving mode. For example, the second driving mode is an autonomous driving mode or an assisted driving mode, and the first driving mode is a manual driving mode, or the first driving mode and the second driving mode may be freely combined, which are not specifically limited in embodiments of the present disclosure.

As shown in section (a) in FIG. 1, the computer device displays, at the pre-prompt stage before the vehicle exits the first driving mode, the switch location identifier 102 on the navigation route. A first information prompt location 105 and a second information prompt location 106 are further arranged before the switch location identifier 102.

For example, as shown in section (b) in FIG. 1, when the dynamic location identifier 103 arrives at the first information prompt location 105, the switch location identifier 102 is displayed on the navigation route, and a path guide identifier 104 and a navigation map panel 107 are displayed in the navigation interface 101. The first information prompt location 105 is a location that is from the switch location identifier 102 by a first threshold on the navigation route.

For example, when the dynamic location identifier 103 corresponding to the vehicle arrives at a location that is from the switch location identifier 102 by 600 meters, in other words, when the dynamic location identifier 103 corresponding to the vehicle arrives at the first information prompt location 105, the switch location identifier 102 is displayed on the navigation route, and the path guide identifier 104 and the navigation map panel 107 are displayed in the navigation interface 101.

For example, as shown in section (c) in FIG. 1, when the dynamic location identifier 103 arrives at the second information prompt location 106, the switch location identifier 102 is displayed on the navigation route, the path guide identifier 104 and the navigation map panel 107 are displayed in the navigation interface 101, and first prompt information 108 is transmitted. The second information prompt location 106 is a location that is from the switch location identifier 102 by a second threshold on the navigation route. The second threshold is smaller than the first threshold.

In some embodiments, the first prompt information includes at least one of displaying a flashing alert in the navigation interface, displaying a full-screen alert in the navigation interface, steering wheel vibration, or seatbelt tightening, but is not limited thereto, which is not specifically limited in embodiments of the present disclosure. The first prompt information 108 in FIG. 1 includes only displaying a flashing alert in the navigation interface and displaying a full-screen alert in the navigation interface.

For example, when the dynamic location identifier 103 corresponding to the vehicle arrives at a location that is from the switch location identifier 102 by 300 meters, in other words, when the dynamic location identifier 103 corresponding to the vehicle arrives at the second information prompt location 106, the switch location identifier 102 is displayed on the navigation route, and the path guide identifier 104, the navigation map panel 107, and the first prompt information 108 are displayed in the navigation interface 101.

In some embodiments, the navigation map panel 107 includes information of at least one of a distance progress bar between the dynamic location identifier 103 and the switch location identifier 102, numeric distance prompt information, or a navigation route thumbnail.

For example, the computer device displays a corresponding first safety boundary identifier on the navigation route in response to a traveling state of the current vehicle being a vehicle-following state. The first safety boundary identifier is configured for indicating a predicted location at which the current vehicle keeps a safe driving distance from a preceding vehicle. The first safety boundary identifier is configured for indicating a critical location that is obtained through prediction and that ensures that the current vehicle does not collide with the preceding vehicle.

For example, the computer device displays a corresponding second safety boundary identifier on the navigation route in response to a traveling state of the current vehicle being an obstacle-avoiding state. The second safety boundary identifier is configured for indicating a predicted location at which the current vehicle is to stop and keeps a safe driving distance from an obstacle. The second safety boundary identifier is configured for indicating a critical location that is obtained through prediction and that ensures that the current vehicle does not collide with the obstacle.

In conclusion, in the method provided in this embodiment, a dynamic location identifier corresponding to a vehicle is displayed in an electronic map in a navigation interface; and a switch location identifier is displayed on a navigation route at a pre-prompt stage before the vehicle exits a first driving mode. In the present disclosure, displaying a switch location identifier on a navigation route in a navigation interface allows a driver to clearly know driving mode switch time of a vehicle, so that dangers caused by unpredictable specific switch time of driving mode switch during traveling of the vehicle can be effectively avoid, thereby improving vehicle driving safety.

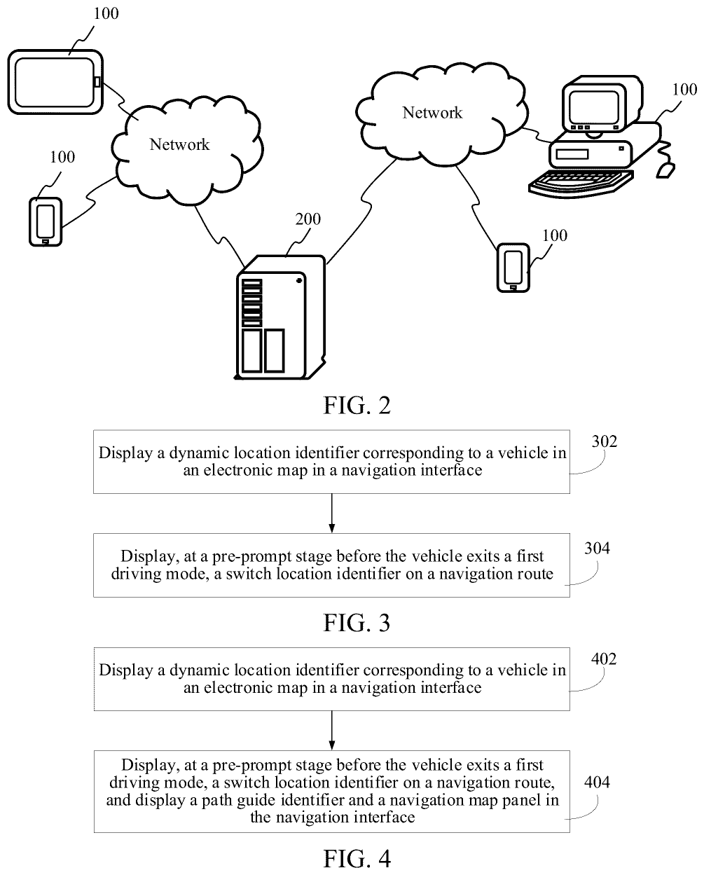

FIG. 2 is a schematic diagram of an architecture of a computer system according to an embodiment of the present disclosure. The computer system may include: a terminal 100 and a server 200.

The terminal 100 may be an electronic device terminal such as a mobile phone, a tablet computer, a vehicle-mounted terminal (vehicle computer), a wearable device, a personal computer (PC), a smart voice interaction device, a smart home appliance, an aerial vehicle, or a self-service vending terminal. A client running a target application may be installed in the terminal 100. The target application may be a map application or another application that provides a navigation function, which is not limited in the present disclosure. In addition, a form of the target application is not limited in the present disclosure, including but not limited to a form of an application (App) installed in the terminal 100, a mini program, or a webpage.

The server 200 may be an independent physical server, may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The server 200 may be a backend server of the foregoing target application and is configured to provide a backend service for the client of the target application.

Cloud technology is a hosting technology that integrates resources, such as hardware, software, and a network, to implement data computing, storage, processing, and sharing in a wide area network or a local area network. The cloud technology is a general term of network technologies, information technologies, integration technologies, management platform technologies, application technologies, and other technologies applied to a cloud computing business model, and creates a resource pool to satisfy what is needed in a flexible and convenient manner. A cloud computing technology is to be the backbone. A lot of computing resources and storage resources are needed for backend services in a technical network system, such as video websites, picture websites and other portal websites. With advanced development and application of the Internet industry, each object is likely to have a recognition flag. These flags need to be transmitted to a backend system for logical processing, and data at different levels may be processed separately. Therefore, data processing in all industries requires a strong system to support, and is implemented only through cloud computing technologies.

In some embodiments, the server may alternatively be implemented as a node in a blockchain system. Blockchain is a new application mode of computer technologies, such as distributed data storage, peer-to-peer transmission, consensus mechanism, and encryption algorithm. Blockchain is essentially a decentralized database or a string of data blocks produced by employing cryptographic methods. Each data block includes a batch of network transaction information to verify information validity (anti-counterfeiting) of the transaction information and generate a next block. Blockchain includes a blockchain underlying platform, a platform product service layer, and an application service layer.

The terminal device 100 may communicate with the server 200 via a network, such as a wired or wireless network.

Operations of the navigation interface prompt method provided in embodiments of the present disclosure may be performed by a computer device. The computer device is an electronic device having a capability of data computing, processing, and storage. In an example of a solution implementation environment shown in FIG. 2, the navigation interface prompt method or a method for indicating a driving mode change may be performed by the terminal 100 (for example, the client that runs the target application and that is installed in the terminal 100 performs the navigation interface prompt method or the method for indicating a driving mode change); the navigation interface prompt method or the method for indicating a driving mode change may be performed by the server 200; or the navigation interface prompt method or the method for indicating a driving mode change is performed by the terminal 100 and the server 200 in interactive cooperation, which is not limited in the present disclosure.

FIG. 3 is a flowchart of a navigation interface prompt method according to an exemplary embodiment of the present disclosure. The method may be performed by a computer device. The computer device may include the terminal 100 and/or the server 200 in FIG. 2. The method includes the following operations:

### Operation 302: Display a Dynamic Location Identifier Corresponding to a Vehicle in an Electronic Map in a Navigation Interface.

The navigation interface is configured to display a navigation route.

The dynamic location identifier is a corresponding identifier of the vehicle displayed in the electronic map. The dynamic location identifier is configured for indicating a real-time location of the vehicle on the navigation route, and the current vehicle is in a first driving mode.

In some embodiments, the navigation interface includes at least one of a navigation estimated end moment, navigation estimated travel duration, or a road congestion condition, but is not limited thereto, which is not specifically limited in embodiments of the present disclosure. The navigation route is a route referenced by the current vehicle during traveling.

In some embodiments, a size of the electronic map is related to a map range of the electronic map in the navigation interface. In other words, a size of the electronic map in the navigation interface is related to a display scaling ratio of the electronic map in the navigation interface. A larger scaling ratio of the electronic map (that is, the electronic map is displayed in an enlarged manner) indicates that a smaller area can be displayed in the navigation interface, and in this case, the whole navigation route may not be displayed. A smaller scaling ratio of the electronic map (that is, the electronic map is displayed in a reduced manner) indicates that a larger area can be displayed in the navigation interface, and in this case, the whole navigation route may be displayed in the navigation interface.

The scaling ratio of the electronic map is preset; the scaling ratio of the electronic map is customized and manually adjusted; or the scaling ratio of the electronic map is adjusted correspondingly in real time based on a distance between a current location of the vehicle and a navigation end location, but is not limited thereto, which is not specifically limited in embodiments of the present disclosure.

### Operation 304: Display, at a Pre-Prompt Stage Before the Vehicle Exits the First Driving Mode, a Switch Location Identifier on the Navigation Route.

The switch location identifier is configured for indicating a predicted location at which the current vehicle exits the first driving mode and switches to a second driving mode. The switch location identifier is configured for indicating an actual switch location at which the current vehicle switches from the first driving mode to the second driving mode. The pre-prompt stage is a stage before the vehicle exits the first driving mode.

In some embodiments, the pre-prompt stage is a stage corresponding to a time threshold before the vehicle exits the first driving mode. For example, the vehicle exits the first driving mode after three minutes, and the three-minute stage is the pre-prompt stage. Alternatively, the pre-prompt stage is a stage corresponding to a distance threshold before the vehicle exits the first driving mode. For example, the vehicle exits the first driving mode after traveling one kilometer, and the one-kilometer stage is the pre-prompt stage. The pre-prompt stage is not limited thereto and is not specifically limited in embodiments of the present disclosure.

In some embodiments, the switch location identifier is at least one of a boundary line, an X identifier, or an identifier with X superimposed on AUTO, but is not limited thereto. A form of the switch location identifier is not specifically limited in embodiments of the present disclosure.

In some embodiments, the first driving mode is an autonomous driving mode or an assisted driving mode, and the second driving mode is a manual driving mode; the first driving mode is a fuel-powered driving mode or a fuel-gas-powered driving mode, and the second driving mode is an electric driving mode; the first driving mode is a fuel-powered driving mode, and the second driving mode is a fuel-gas-powered driving mode; or the first driving mode is a sport mode, and the second driving mode is a snow mode. The first driving mode and the second driving mode are not limited thereto and are not specifically limited in embodiments of the present disclosure.

The foregoing examples of the first driving mode and the second driving mode may be switched between the first driving mode and the second driving mode. For example, the second driving mode is an autonomous driving mode or an assisted driving mode, and the first driving mode is a manual driving mode, or the first driving mode and the second driving mode may be freely combined, which are not specifically limited in embodiments of the present disclosure.

The autonomous driving mode is a driving mode that does not require manual intervention.

The manual driving mode is a driving mode that requires manual intervention.

The assisted driving mode is a driving mode for assisting manual intervention. For example, during traveling of the current vehicle, the current vehicle recognizes a mark line of a traveling lane by using a camera. If the vehicle approaches the recognized mark line and may leave the traveling lane, a driver may be alerted through steering wheel vibration.

For example, the computer device displays the switch location identifier on the navigation route in response to the vehicle being at the pre-prompt stage in which the vehicle is to exit the first driving mode, and the switch location identifier is configured for providing the driver with a prompt of the predicted location at which the current vehicle exits the first driving mode and switches to the second driving mode. In this way, a location at which the vehicle switches the driving mode can be fully expected by the driver, and the driver is not in a hurry even though the driver cannot take control of the vehicle at present, so that vehicle driving safety can be improved.

In conclusion, in the method provided in this embodiment, a dynamic location identifier corresponding to a vehicle is displayed in an electronic map in a navigation interface; and a switch location identifier is displayed on a navigation route at a pre-prompt stage before the vehicle exits a first driving mode. In the present disclosure, displaying a switch location identifier on a navigation route in a navigation interface allows a driver to clearly know driving mode switch time of a vehicle, so that dangers caused by unpredictable situations such as driving mode switch during traveling of the vehicle can be effectively avoid, thereby improving vehicle driving safety.

FIG. 4 is a flowchart of a navigation interface prompt method according to an exemplary embodiment of the present disclosure. The method may be performed by a computer device. The computer device may include the terminal 100 and/or the server 200 in FIG. 2. The method includes the following operations:

### Operation 402: Display a Dynamic Location Identifier Corresponding to a Vehicle in an Electronic Map in a Navigation Interface.

The navigation interface is configured to display a navigation route. The dynamic location identifier is a corresponding identifier of the vehicle displayed in the electronic map. The dynamic location identifier is configured for indicating a real-time location of the vehicle on the navigation route, and the current vehicle is in a first driving mode.

For example, in terms of changing the driving mode of the current vehicle, in addition to receiving an instruction for changing the driving mode, the current vehicle may further autonomously detect whether road condition information meet a preset condition, and change the driving mode when the road condition information meets the preset condition. For example, the first driving mode is an autonomous driving mode, and the second driving mode is a manual driving mode.

For example, the preset condition includes at least one of the following: a traffic speed being less than a first speed threshold, a traffic flow being greater than a second quantity threshold, a road being cutoff, a road being maintained, an object being dropped on a road, or road weather being severe weather. The first speed threshold and the second quantity threshold may be determined by a technician based on an actual driving scenario. For example, it is assumed that the first speed threshold being 10 km/h indicates road congestion, and that the second quantity threshold being 20 vehicles/lane indicates road congestion.

For example, whether the traffic speed is less than the first speed threshold is detected. If the traffic speed is less than the first speed threshold, it indicates that there may be congestion in a road section. To ensure safety of a driver, the current vehicle exits the autonomous driving mode.

For example, whether the traffic flow is greater than the second quantity threshold is detected. If the traffic flow is greater than the second quantity threshold, it indicates that there is a large traffic flow and congestion in a road section. To ensure safety of a driver, the current vehicle exits the autonomous driving mode.

For example, whether a road is cut off is detected. If the road is cut off, it indicates that a vehicle cannot travel on the road section. To ensure safety of a driver, the current vehicle exits the autonomous driving mode.

For example, whether a road is maintained is detected. If the road is maintained, it indicates that a vehicle needs to carefully travel on the road section or bypass the road section. To ensure safety of a driver, the current vehicle exits the autonomous driving mode.

For example, whether an object is dropped on a road is detected. If an object is dropped on a road, it indicates that a vehicle needs to carefully travel on the road section or bypass the road section. To ensure safety of a driver, the current vehicle exits the autonomous driving mode. In another embodiment, if an object is dropped on a road, whether a size of the dropped object is greater than a third size threshold is further detected. If the size of the dropped object is greater than the third size threshold, the current vehicle exits the autonomous driving mode. If the size of the dropped object is less than the third size threshold, the current vehicle does not change the driving mode. When an object is dropped on a road, a size of the dropped object may have different impacts on the autonomous driving mode. For example, if the dropped object is a piece of paper, the dropped object on the road has almost no impact on the autonomous driving mode, and the autonomous driving mode may not be changed. If the dropped object is a stone, the object dropped on the road has a large impact on the autonomous driving mode, and in this case, the current vehicle exits the autonomous driving mode. The size of the dropped object is detected, to determine whether to change the driving mode, which is more reasonable and accurate.

For example, whether road weather is severe weather is detected. If the road weather is severe weather, it indicates that a vehicle needs to carefully travel on the road section. To ensure safety of a driver, the current vehicle exits the autonomous driving mode. The severe weather may be heavy fog weather, heavy rain weather, or snowy weather. A type of the severe weather is not limited in embodiments of the present disclosure.

In an embodiment, a plurality of rules may be preset. For example, the traffic speed is less than the first speed threshold, the traffic flow is greater than the second quantity threshold, or the road is cutoff, and these rules are respectively used for matching. If one rule is hit, the current vehicle exits the autonomous driving mode. If none of the rules is hit, the driving mode is not changed. In addition, the matching of the rules may be performed simultaneously or sequentially.

### Operation 404: Display, at a Pre-Prompt Stage Before the Vehicle Exits the First Driving Mode, a Switch Location Identifier on the Navigation Route, and Display a Path Guide Identifier and a Navigation Map Panel in the Navigation Interface.

The switch location identifier is configured for indicating a predicted location at which the current vehicle exits the first driving mode and switches to a second driving mode. The switch location identifier is configured for indicating an actual switch location at which the current vehicle switches from the first driving mode to the second driving mode. The pre-prompt stage is a stage before the vehicle exits the first driving mode.

For example, the computer device displays, at the pre-prompt stage before the vehicle exits the first driving mode, the switch location identifier on the navigation route, and displays the path guide identifier and the navigation map panel in the navigation interface.

The path guide identifier is a guide identifier indicating that the dynamic location identifier corresponding to the current vehicle moves to the switch location identifier. In some embodiments, the path guide identifier is displayed in a form of a distance indicator, with a distance progress bar between the switch location identifier marked on the distance indicator. The switch location identifier is at the end of the distance indicator, and the current vehicle is at the start of the distance indicator. In an embodiment, the path guide identifier displays a plurality of distance sections.

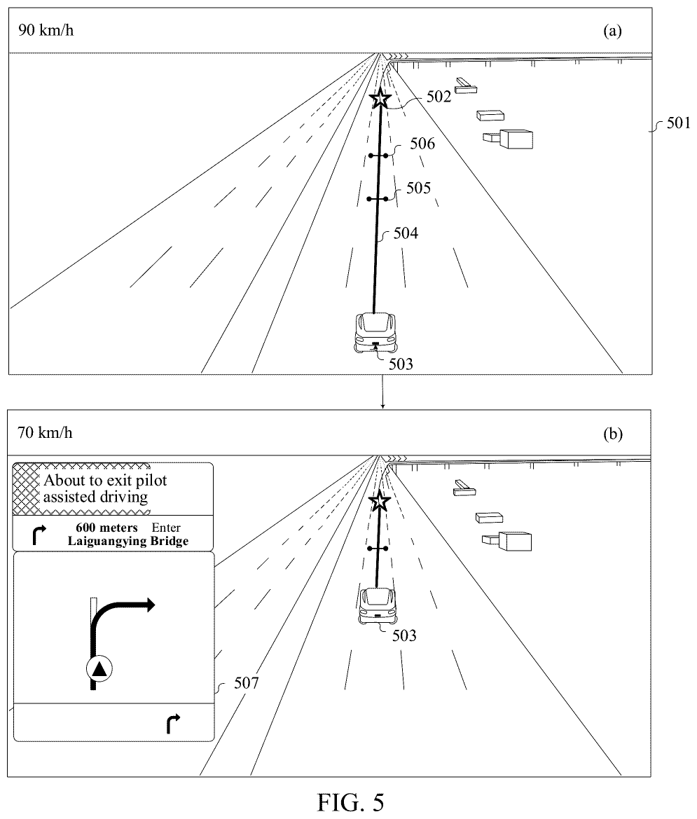

In an embodiment, as shown in section (a) in FIG. 5, the computer device displays, at the pre-prompt stage before the vehicle exits the first driving mode, a switch location identifier 502 on a navigation route. A first information prompt location 505 and a second information prompt location 506 are further arranged before a switch location identifier 502.

For example, as shown in section (b) in FIG. 5, FIG. 5 shows that a vehicle arrives at the first information prompt location 505 at this time. When a dynamic location identifier 503 arrives at the first information prompt location 505, the switch location identifier 502 is displayed on the navigation route, and a path guide identifier 504 and a navigation map panel 507 are displayed in a navigation interface 501.

The first information prompt location 505 is a location that is from the switch location identifier 502 by a first threshold on the navigation route. In some embodiments, the first threshold indicates a linear distance or a curvilinear distance between the first information prompt location 505 and the switch location identifier 502, which is not limited in embodiments of the present disclosure.

For example, when the dynamic location identifier 503 corresponding to the vehicle arrives at a location that is from the switch location identifier 502 by 600 meters, in other words, when the dynamic location identifier 503 corresponding to the vehicle arrives at the first information prompt location 505, the switch location identifier 502 is displayed on the navigation route, and the path guide identifier 504 and the navigation map panel 507 are displayed in the navigation interface 501.

In some embodiments, the navigation map panel 507 includes information of at least one of a distance progress bar between the dynamic location identifier 503 and the switch location identifier 502, numeric distance prompt information, or a navigation route thumbnail. An area at which “about to exit pilot assisted driving” shown in FIG. 5 is located in the distance progress bar. The area being filled with gray color indicates that the distance progress bar is complete, in other words, the dynamic location identifier 503 arrives at a location of the switch location identifier 502.

In an embodiment, the path guide identifier displays a plurality of distance sections. If the dynamic location identifier of the current vehicle does not arrive at the first information prompt location, a first remaining distance section between the dynamic location identifier and the first information prompt location, a first distance section between the first information prompt location and the second information prompt location, and a second distance section between the second information prompt location and the switch location identifier are displayed on the path guide identifier.

For example, the first remaining distance section has a safety representation feature, the first distance section has an alert representation feature, and the second distance section has a danger representation feature. In some embodiments, the path guide identifier is displayed in a geometric shape such as a rectangle, a rounded rectangle, a rhombus, or a trapezoid. In some embodiments, the representation feature is a color feature. The first remaining distance section is displayed as a geometric shape having a safety color, the first distance section is displayed as a geometric shape having an alert color, and the second distance section is displayed as a geometric shape having a danger color. In some embodiments, the safety color is green, the alert color is yellow, and the danger color is red.

In some embodiments, the representation feature is a pattern feature. The first remaining distance section is displayed as a geometric shape having a safety pattern, the first distance section is displayed as a geometric shape having an alert pattern, and the second distance section is displayed as a geometric shape having a danger pattern. In some embodiments, the safety pattern is a smile face pattern, the alert pattern is a nervous expression pattern, and the danger pattern is a frightened expression pattern.

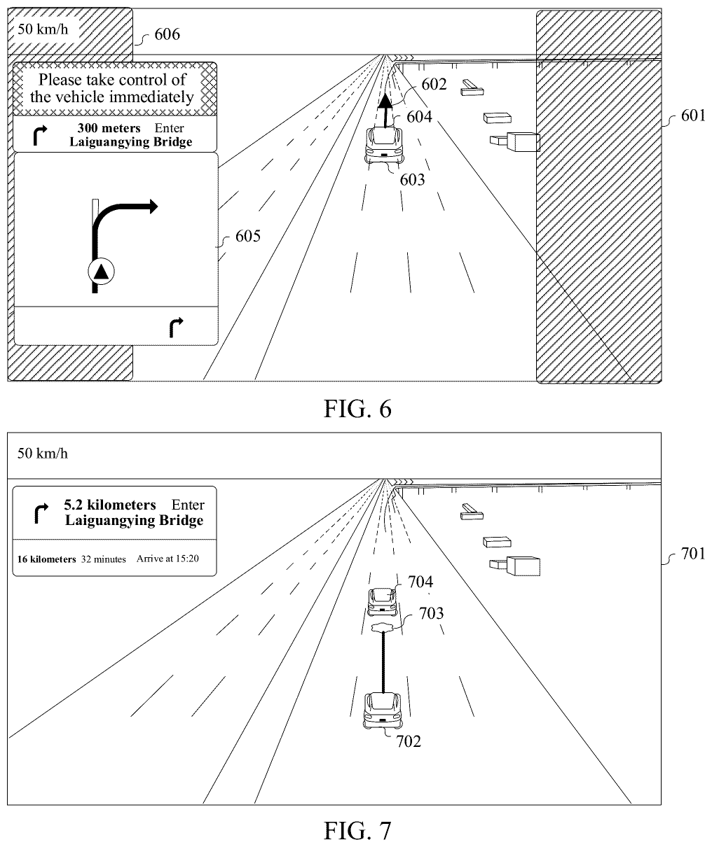

In an embodiment, as shown in FIG. 6, a dynamic location identifier 603 corresponding to a vehicle is displayed in an electronic map in a navigation interface 601. When the dynamic location identifier 603 arrives at a second information prompt location, a switch location identifier 602 is displayed on a navigation route, and a path guide identifier 604, a navigation map panel 605, and first prompt information 606 are displayed in the navigation interface 601. The second information prompt location is a location that is from the switch location identifier 602 by a second threshold on the navigation route. The second threshold is smaller than the first threshold. In some embodiments, the second threshold indicates a linear distance or a curvilinear distance between the second information prompt location and the switch location identifier, which is not limited in embodiments of the present disclosure. In some embodiments, the first prompt information 606 includes at least one of an alert sound, displaying a flashing alert in the navigation interface 601, displaying a full-screen alert in the navigation interface 601, steering wheel vibration, or seatbelt tightening, but is not limited thereto, which is not specifically limited in embodiments of the present disclosure.

For example, when the dynamic location identifier 603 corresponding to the vehicle arrives at a location that is from the switch location identifier 602 by 300 meters, in other words, when the dynamic location identifier 603 corresponding to the vehicle arrives at the second information prompt location, the switch location identifier 602 is displayed on the navigation route, and the path guide identifier 604, the navigation map panel 605, and the first prompt information 606 are displayed in the navigation interface 601.

In an embodiment, the path guide identifier displays a plurality of distance sections. If the dynamic location identifier of the current vehicle is between the first information prompt location and the second information prompt location, a second remaining distance section between the dynamic location identifier and the second information prompt location and a second distance section between the second information prompt location and the switch location identifier are displayed on the path guide identifier.

For example, the second remaining distance section has an alert representation feature, and the second distance section has a danger representation feature. In some embodiments, the path guide identifier is displayed in a geometric shape such as a rectangle, a rounded rectangle, a rhombus, or a trapezoid. In some embodiments, the representation feature is a color feature. The second remaining distance section is displayed as a geometric shape having an alert color, and the second distance section is displayed as a geometric shape having a danger color. In some embodiments, the alert color is yellow, and the danger color is red.

In some embodiments, the representation feature is a pattern feature. The second remaining distance section is displayed as a geometric shape having an alert pattern, and the second distance section is displayed as a geometric shape having a danger pattern. In some embodiments, the alert pattern is a nervous expression pattern, and the danger pattern is a frightened expression pattern.

In an embodiment, the computer device displays a corresponding first safety boundary identifier on the navigation route in response to a traveling state of the current vehicle being a vehicle-following state. The first safety boundary identifier is configured for indicating a predicted location at which the current vehicle keeps a safe driving distance from a preceding vehicle. The first safety boundary identifier is configured for indicating a critical location that is obtained through prediction and that ensures that the current vehicle does not collide with the preceding vehicle.

FIG. 7 is a schematic diagram of a navigation interface prompt method. A dynamic location identifier 702 corresponding to a current vehicle and a dynamic location identifier 704 corresponding to another vehicle are displayed in an electronic map in a navigation interface 701. When a traveling state of the current vehicle is a vehicle-following state, a corresponding first safety boundary identifier 703 is displayed on a navigation route. The display of the first safety boundary identifier 703 allows a driver to know that the current vehicle is in the vehicle-following state and is keeping a safe driving distance, so that vehicle driving safety can be improved, thereby enhancing a sense of safety for the driver.

For example, when the traveling state of the current vehicle is the vehicle-following state, the first safety boundary identifier 703 is displayed 10 meters ahead of the dynamic location identifier 702 corresponding to the current vehicle, to indicate that the current vehicle is in the vehicle-following state and is keeping a safe driving distance.

In an embodiment, the computer device displays a corresponding second safety boundary identifier on the navigation route in response to a traveling state of the current vehicle being an obstacle-avoiding state. The second safety boundary identifier is configured for indicating a predicted location at which the current vehicle is to stop and keeps a safe driving distance from an obstacle. The second safety boundary identifier is configured for indicating a critical location that is obtained through prediction and that ensures that the current vehicle does not collide with the obstacle.

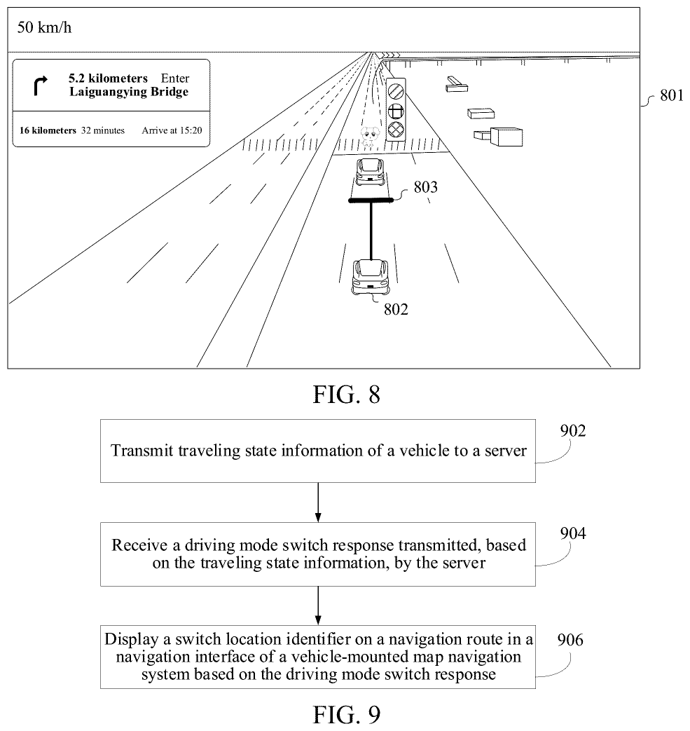

FIG. 8 is a schematic diagram of a navigation interface prompt method. A dynamic location identifier 802 corresponding to a current vehicle is displayed in an electronic map in a navigation interface 801. When a traveling state of the current vehicle is an obstacle-avoiding state or a traffic signal awaiting state, a corresponding second safety boundary identifier 803 is displayed on a navigation route. The display of the second safety boundary identifier 803 allows a driver to know that the current vehicle is in the obstacle-avoiding state or the traffic signal awaiting state, that is, the current vehicle is to stop. The second safety boundary identifier 803 shows, to the driver, that the current vehicle is to stop at a location before the second safety boundary identifier 803 and is keeping a safe driving distance from a preceding vehicle or an obstacle, so that vehicle driving safety can be improved, thereby enhancing a sense of safety for the driver.

For example, when the traveling state of the current vehicle is the traffic signal awaiting state, the second safety boundary identifier 803 is displayed two meters ahead of the dynamic location identifier 802 corresponding to the current vehicle, to indicate that the current vehicle is to stop at a location before the second safety boundary identifier 803 and that the second safety boundary identifier 803 keeps a safe driving distance from a white solid line or the preceding vehicle.

In conclusion, in the method provided in this embodiment, a dynamic location identifier corresponding to a vehicle is displayed in an electronic map in a navigation interface; and at a pre-prompt stage before the vehicle exits the first driving mode, a switch location identifier is displayed on the navigation route, and a path guide identifier and a navigation map panel are displayed in the navigation interface. In the present disclosure, displaying a switch location identifier on a navigation route in a navigation interface and displaying a path guide identifier and a navigation map panel in the navigation interface allow a driver to clearly know driving mode switch time of a vehicle from a plurality of perspectives, so that dangers caused by an unpredictable specific time point of driving mode switch during traveling of the vehicle can be effectively avoid, thereby improving vehicle driving safety.

FIG. 9 is a flowchart of a method for indicating a driving mode change according to an exemplary embodiment of the present disclosure. The method is applied to a vehicle having a vehicle-mounted map navigation system. The method includes the following operations:

### Operation 902: Transmit Traveling State Information of a Current Vehicle to a Server.

The traveling state information includes a driving mode of the current vehicle and road condition information.

In some embodiments, the road condition information is a road condition on a traveling route of a vehicle. Each road section for traveling has road condition information, and different road sections for traveling may have the same or different road condition information. For example, the road condition information may be obtained by a road condition information acquisition device, and the road condition information acquisition device may include cameras arranged at different road sections. In an example, the road condition information acquisition device may acquire, in real time, road condition information of a planned road section for traveling of the current vehicle. In another example, the road condition information acquisition device may acquire, every preset duration, road condition information of a planned road section for traveling of the current vehicle.

The road condition information of the planned road section for traveling is configured for indicating a road condition of the planned road section for traveling. The road condition information may include at least one of the following: a traffic speed, a traffic flow, a road cutoff condition, a road maintenance condition, a dropped object condition, or a weather condition. The traffic speed is an average speed of all vehicles passing a planned road section for traveling. The traffic flow is a quantity of vehicles passing, in a specific time period, a planned road section for traveling.

For example, the road cutoff condition is road blockage caused by a river or a hill ahead of a road. The road maintenance condition means that a road is under construction and maintenance. The dropped object condition means that an object dropped on a road. The weather condition is weather such as sunny or cloudy, foggy or snowy weathers. The traffic speed and the traffic flow may be obtained through performing calculation of a video or an image acquired by the road condition information acquisition device. The road cutoff condition, the road maintenance condition, the dropped object condition, and the weather condition may be obtained through performing recognition on the video or the image acquired by the road condition information acquisition device. In an example of the road cutoff condition, a recognition model used for recognizing the road cutoff condition may be obtained through pre-training. A video or an image of a specific road section is inputted into the recognition model, and whether the road section is cut off is inputted by using the recognition model.

For example, the vehicle transmits the driving mode of the current vehicle and the road condition information to the server.

In an embodiment, the server determines, based on the road condition information, to switch from a first driving mode to a second driving mode at a first moment. In an embodiment, the server determines, based on the road condition information, to switch from a first driving mode to a second driving mode after the vehicle travels a first distance.

### Operation 904: Receive a Driving Mode Switch Response Transmitted, Based on the Traveling State Information, by the Server.

The driving mode switch response is configured for instructing the driving mode of the current vehicle to switch from the first driving mode to the second driving mode.

In some embodiments, the driving mode switch response is response information carrying time information. For example, the driving mode of the current vehicle switches from the first driving mode to the second driving mode after three minutes. Alternatively, the driving mode switch response is response information carrying distance information. For example, the driving mode of the current vehicle switches from the first driving mode to the second driving mode after the current vehicle travels one kilometer. The driving mode switch response is not limited thereto and is not specifically limited in embodiments of the present disclosure.

In some embodiments, the first driving mode is an autonomous driving mode or an assisted driving mode, and the second driving mode is a manual driving mode; the first driving mode is a fuel-powered driving mode or a fuel-gas-powered driving mode, and the second driving mode is an electric driving mode; the first driving mode is a fuel-powered driving mode, and the second driving mode is a fuel-gas-powered driving mode; or the first driving mode is a sport mode, and the second driving mode is a snow mode. The first driving mode and the second driving mode are not limited thereto and are not specifically limited in embodiments of the present disclosure.

The foregoing examples of the first driving mode and the second driving mode may be switched between the first driving mode and the second driving mode. For example, the second driving mode is an autonomous driving mode or an assisted driving mode, and the first driving mode is a manual driving mode, or the first driving mode and the second driving mode may be freely combined, which are not specifically limited in embodiments of the present disclosure.

The autonomous driving mode is a driving mode that does not require manual intervention.

The manual driving mode is a driving mode that requires manual intervention.

The assisted driving mode is a driving mode for assisting manual intervention. For example, during traveling of the current vehicle, the current vehicle recognizes a mark line of a traveling lane by using a camera. If the vehicle approaches the recognized mark line and may leave the traveling lane, a driver may be alerted through steering wheel vibration.

### Operation 906: Display a Switch Location Identifier on a Navigation Route in a Navigation Interface of the Vehicle-Mounted Map Navigation System Based on the Driving Mode Switch Response.

In an embodiment, the driving mode switch response is the response information carrying the time information. The current vehicle obtains a location of the switch location identifier on the navigation route based on the time information and in combination with a movement speed of the current vehicle. In some embodiments, the time information is countdown duration of switching the driving mode. For example, the time information is that the first driving mode is switched to the second driving mode after three minutes, and the movement speed of the current vehicle is 20 km/h. In this case, it can be obtained that the current vehicle is to switch from the first driving mode to the second driving mode after 1 km. Based on a scaling ratio of an electronic map, the switch location identifier is displayed at a corresponding location 1 km from the current vehicle on the navigation route.

In an embodiment, the driving mode switch response is the response information carrying the distance information. The current vehicle obtains a location of the switch location identifier on the navigation route based on the distance information. In some embodiments, the distance information is a countdown distance of switching the driving mode. For example, the distance information is that the first driving mode is switched to the second driving mode after 1 km. Based on a scaling ratio of an electronic map, the switch location identifier is displayed at a corresponding location 1 km from the current vehicle on the navigation route.

The switch location identifier is configured for indicating a predicted location at which the current vehicle exits the first driving mode and switches to the second driving mode. The switch location identifier is configured for indicating an actual switch location at which the current vehicle switches from the first driving mode to the second driving mode. In some embodiments, the switch location identifier is at least one of a boundary line, an X identifier, or an identifier with X superimposed on AUTO, but is not limited thereto. A form of the switch location identifier is not specifically limited in embodiments of the present disclosure.

The navigation interface is configured to display the navigation route. In some embodiments, the navigation interface includes at least one of a navigation estimated end moment, navigation estimated travel duration, or a road congestion condition, but is not limited thereto, which is not specifically limited in embodiments of the present disclosure. The navigation route is a route referenced by the current vehicle during traveling.

In some embodiments, a size of the electronic map in the navigation interface of the vehicle-mounted map navigation system is related to a map range of the electronic map in the navigation interface. In other words, a size of the electronic map in the navigation interface is related to a display scaling ratio of the electronic map in the navigation interface. A larger scaling ratio of the electronic map (that is, the electronic map is displayed in an enlarged manner) indicates that a smaller area can be displayed in the navigation interface, and in this case, the whole navigation route may not be displayed. A smaller scaling ratio of the electronic map (that is, the electronic map is displayed in a reduced manner) indicates that a larger area can be displayed in the navigation interface, and in this case, the whole navigation route may be displayed in the navigation interface.

The scaling ratio of the electronic map is preset; the scaling ratio of the electronic map is customized and manually adjusted; or the scaling ratio of the electronic map is adjusted correspondingly in real time based on a distance between a current location of the vehicle and a navigation end location, but is not limited thereto, which is not specifically limited in embodiments of the present disclosure.

For example, the current vehicle displays the switch location identifier on the navigation route in the navigation interface of a vehicle-mounted map navigation system based on the driving mode switch response, to provide, through the switch location identifier, the driver with a prompt of the predicted location at which the current vehicle exits the first driving mode and switches to the second driving mode. In this way, a location at which the vehicle switches the driving mode can be fully expected by the driver, and the driver is not in a hurry even though the driver cannot take control of the vehicle at present, so that vehicle driving safety can be improved.

In conclusion, in the method provided in this embodiment, traveling state information of a current vehicle is transmitted to a server; a driving mode switch response transmitted by the server based on the traveling state information is received; and the vehicle displays a switch location identifier on a navigation route in a navigation interface of a vehicle-mounted map navigation system based on the driving mode switch response. In the present disclosure, displaying a switch location identifier on a navigation route in a navigation interface allows a driver to clearly know driving mode switch time of a vehicle, so that dangers caused by unpredictable situations such as driving mode switch during traveling of the vehicle can be effectively avoid, thereby improving vehicle driving safety.

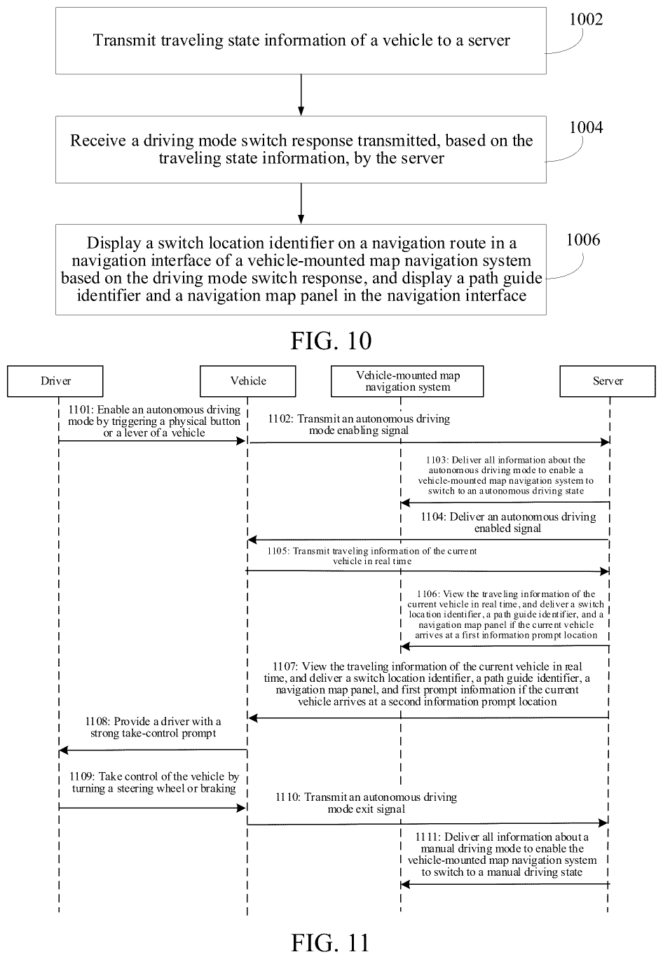

FIG. 10 is a flowchart of a method for indicating a driving mode change according to an exemplary embodiment of the present disclosure. The method is applied to a vehicle having a vehicle-mounted map navigation system. The method may be performed by the terminal 100 in FIG. 2. The method includes the following operations:

### Operation 1002: Transmit Traveling State Information of a Current Vehicle to a Server.

The traveling state information includes a driving mode of the current vehicle and road condition information. For example, the vehicle transmits the driving mode of the current vehicle and the road condition information to the server.

### Operation 1004: Receive a Driving Mode Switch Response Transmitted, Based on the Traveling State Information, by the Server.

The driving mode switch response is configured for instructing the driving mode of the current vehicle to switch from a first driving mode to a second driving mode.

For example, in terms of the driving mode switch response received by the current vehicle, in addition to a driving mode switch response obtained through receiving, by the server, an instruction for changing the driving mode, the current vehicle may further autonomously detect whether road condition information meet a preset condition, and autonomously generate a driving mode switch response when the road condition information meets the preset condition. An example of an autonomous driving mode and a manual driving mode is used.

For example, the preset condition includes at least one of the following: a traffic speed being less than a first speed threshold, a traffic flow being greater than a second quantity threshold, a road being cutoff, a road being maintained, an object being dropped on a road, or road weather being severe weather. The first speed threshold and the second quantity threshold may be determined by a technician based on an actual driving scenario. For example, it is assumed that the first speed threshold being 10 km/h indicates road congestion, and that the second quantity threshold being 20 vehicles/lane indicates road congestion.

For example, whether the traffic speed is less than the first speed threshold is detected. If the traffic speed is less than the first speed threshold, it indicates that there may be congestion in a road section. To ensure safety of a driver, the driving mode switch response instructs the current vehicle to exit the autonomous driving mode.

For example, whether the traffic flow is greater than the second quantity threshold is detected. If the traffic flow is greater than the second quantity threshold, it indicates that there is a large traffic flow and congestion in a road section. To ensure safety of a driver, the driving mode switch response instructs the current vehicle to exit the autonomous driving mode.

For example, whether a road is cut off is detected. If the road is cut off, it indicates that a vehicle cannot travel on the road section. To ensure safety of a driver, the driving mode switch response instructs the current vehicle to exit the autonomous driving mode.

For example, whether a road is maintained is detected. If the road is maintained, it indicates that a vehicle needs to carefully travel on the road section or bypass the road section. To ensure safety of a driver, the driving mode switch response instructs the current vehicle to exit the autonomous driving mode.

For example, whether an object is dropped on a road is detected. If an object is dropped on a road, it indicates that a vehicle needs to carefully travel on the road section or bypass the road section. To ensure safety of a driver, the driving mode switch response instructs the current vehicle to exit the autonomous driving mode. In another embodiment, if an object is dropped on a road, whether a size of the dropped object is greater than a third size threshold is further detected. If the size of the dropped object is greater than the third size threshold, the current vehicle exits the autonomous driving mode. If the size of the dropped object is less than the third size threshold, the driving mode switch response instructs the current vehicle not to change the driving mode. When an object is dropped on a road, a size of the dropped object may have different impacts on the autonomous driving mode. For example, if the dropped object is a piece of paper, the dropped object on the road has almost no impact on the autonomous driving mode, and the driving mode switch response gives an instruction that the current vehicle may keep the autonomous driving mode unchanged. If the dropped object is a stone, the object dropped on the road has a large impact on the autonomous driving mode, and in this case, the driving mode switch response instructs the current vehicle to exit the autonomous driving mode. The size of the dropped object is detected, to determine whether to change the driving mode, which is more reasonable and accurate.

For example, whether road weather is severe weather is detected. If the road weather is severe weather, it indicates that a vehicle needs to carefully travel on the road section. To ensure safety of a driver, the driving mode switch response instructs the current vehicle to exit the autonomous driving mode. The severe weather may be heavy fog weather, heavy rain weather, or snowy weather. A type of the severe weather is not limited in embodiments of the present disclosure.

In an embodiment, a plurality of rules may be preset. For example, the traffic speed is less than the first speed threshold, the traffic flow is greater than the second quantity threshold, or the road is cutoff, and these rules are respectively used for matching. If one rule is hit, the driving mode switch response instructs the current vehicle to exit the autonomous driving mode. If none of the rules is hit, the driving mode is not changed. In addition, the matching of the rules may be performed simultaneously or sequentially.

Operation 1006: Display a Switch Location Identifier on a Navigation Route in a Navigation Interface of the Vehicle-Mounted Map Navigation System Based on the Driving Mode Switch Response, and Display a Path Guide Identifier and a Navigation Map Panel in the Navigation Interface.

The switch location identifier is configured for indicating a predicted location at which the current vehicle exits the first driving mode and switches to the second driving mode. The switch location identifier is configured for indicating an actual switch location at which the current vehicle switches from the first driving mode to the second driving mode.

The path guide identifier is a guide identifier indicating that a dynamic location identifier corresponding to the current vehicle moves to the switch location identifier. In some embodiments, the path guide identifier is displayed in a form of a distance indicator, with a distance progress bar between the switch location identifier marked on the distance indicator. The switch location identifier is at the end of the distance indicator, and the current vehicle is at the start of the distance indicator.

In some embodiments, as the dynamic location identifier corresponding to the current vehicle moves toward the switch location identifier, the path guide identifier becomes increasingly shorter, until the path guide identifier disappears when the dynamic location identifier moves to the switch location identifier.

The dynamic location identifier is a corresponding identifier of the vehicle displayed in an electronic map. The dynamic location identifier is configured for indicating a real-time location of the vehicle on the navigation route.

For example, the current vehicle displays the switch location identifier on the navigation route in the navigation interface based on the driving mode switch response when the dynamic location identifier corresponding to the current vehicle arrives at a first information prompt location, and displays the path guide identifier and the navigation map panel in the navigation interface. The first information prompt location is a location that is from the switch location identifier by a first threshold on the navigation route. In some embodiments, the first threshold indicates a linear distance or a curvilinear distance between the first information prompt location and the switch location identifier, which is not limited in embodiments of the present disclosure.

For example, when the dynamic location identifier corresponding to the vehicle arrives at a location that is from the switch location identifier by 600 meters, in other words, when the dynamic location identifier corresponding to the vehicle arrives at the first information prompt location, the switch location identifier is displayed on the navigation route, and the path guide identifier and the navigation map panel are displayed in the navigation interface.

In some embodiments, the navigation map panel includes information of at least one of a distance progress bar between the dynamic location identifier and the switch location identifier, numeric distance prompt information, or a navigation route thumbnail.

For example, the current vehicle displays the switch location identifier on the navigation route in the navigation interface based on the driving mode switch response when the dynamic location identifier corresponding to the current vehicle arrives at a second information prompt location, displays the path guide identifier and the navigation map panel in the navigation interface, and transmits first prompt information. The second information prompt location is a location that is from the switch location identifier by a second threshold on the navigation route. The second threshold is smaller than the first threshold. In some embodiments, the second threshold indicates a linear distance or a curvilinear distance between the second information prompt location and the switch location identifier, which is not limited in embodiments of the present disclosure.

In some embodiments, the first prompt information includes at least one of an alert sound, displaying a flashing alert in the navigation interface, displaying a full-screen alert in the navigation interface, steering wheel vibration, or seatbelt tightening, but is not limited thereto, which is not specifically limited in embodiments of the present disclosure.

In an embodiment, the current vehicle receives a traveling state response transmitted, based on the traveling state information, by the server. The current vehicle displays a safety boundary identifier on the navigation route based on the traveling state response. The safety boundary identifier is configured for indicating a predicted location at which a safe driving distance of the current vehicle is ensured. The traveling state response is configured for indicating a traveling state of the current vehicle.

For example, a corresponding first safety boundary identifier is displayed on the navigation route based on the traveling state of the current vehicle being a vehicle-following state. The first safety boundary identifier is configured for indicating a predicted location at which the current vehicle keeps a safe driving distance from a preceding vehicle. The first safety boundary identifier is configured for indicating a critical location that is obtained through prediction and that ensures that the current vehicle does not collide with the preceding vehicle.

For example, when the traveling state of the current vehicle is the vehicle-following state, the corresponding first safety boundary identifier is displayed on the navigation route. The display of the first safety boundary identifier allows a driver to know that the current vehicle is in the vehicle-following state and is keeping the safe driving distance, so that vehicle driving safety can be improved, thereby enhancing a sense of safety for the driver.

For example, when the traveling state of the current vehicle is the vehicle-following state, the first safety boundary identifier is displayed 10 meters ahead of the dynamic location identifier corresponding to the current vehicle, to indicate that the current vehicle is in the vehicle-following state and is keeping the safe driving distance.

For example, a corresponding second safety boundary identifier is displayed on the navigation route based on a traveling state of the current vehicle being an obstacle-avoiding state. The second safety boundary identifier is configured for indicating a predicted location at which the current vehicle is to stop and keeps a safe driving distance from an obstacle. The second safety boundary identifier is configured for indicating a critical location that is obtained through prediction and that ensures that the current vehicle does not collide with the obstacle.

For example, when the traveling state of the current vehicle is the obstacle-avoiding state or a traffic signal awaiting state, the corresponding second safety boundary identifier is displayed on the navigation route. The display of the second safety boundary identifier allows a driver to know that the current vehicle is in the obstacle-avoiding state or the traffic signal awaiting state, that is, the current vehicle is to stop. The second safety boundary identifier shows, to the driver, that the current vehicle is to stop at a location before the second safety boundary identifier and is keeping the safe driving distance from a preceding vehicle or an obstacle, so that vehicle driving safety can be improved, thereby enhancing a sense of safety for the driver.

For example, when the traveling state of the current vehicle is the traffic signal awaiting state, the second safety boundary identifier is displayed two meters ahead of the dynamic location identifier corresponding to the current vehicle, to indicate that the current vehicle is to stop at a location before the second safety boundary identifier and that the second safety boundary identifier keeps the safe driving distance from a white solid line or the preceding vehicle.

In conclusion, in the method provided in this embodiment, traveling state information of a current vehicle is transmitted to a server; a driving mode switch response transmitted by the server based on the traveling state information is received; and the vehicle displays a switch location identifier on a navigation route in a navigation interface of a vehicle-mounted map navigation system based on the driving mode switch response, and displays a path guide identifier and a navigation map panel in the navigation interface. In the present disclosure, displaying a switch location identifier on a navigation route in a navigation interface and displaying a path guide identifier and a navigation map panel in the navigation interface allow a driver to clearly know driving mode switch time of a vehicle from a plurality of perspectives, so that dangers caused by unpredictable situations such as driving mode switch during traveling of the vehicle can be effectively avoid, thereby improving vehicle driving safety.

FIG. 11 is a flowchart of a navigation interface prompt method according to an exemplary embodiment of the present disclosure.

Operation 1101: Enable an autonomous driving mode by triggering a physical button or a lever of a vehicle.

For example, a driver enables the autonomous driving mode of the current vehicle by triggering the physical button or the lever of the current vehicle. In some embodiments, the driver may enable the autonomous driving mode of the current vehicle in a voice instruction manner.

Operation 1102: Transmit an autonomous driving mode enabling signal.

For example, the current vehicle transmits the autonomous driving mode enabling signal to a server.

Operation 1103: Deliver all information about the autonomous driving mode to enable a vehicle-mounted map navigation system to switch to an autonomous driving state.

For example, after receiving the autonomous driving mode enabling signal, the server delivers all information about the autonomous driving mode to the vehicle-mounted map navigation system of the current vehicle, to enable the vehicle-mounted map navigation system to switch to the autonomous driving state.

Operation 1104: Deliver an autonomous driving enabled signal.

For example, upon delivering all information about the autonomous driving mode to the vehicle-mounted map navigation system of the current vehicle, the server transmits the autonomous driving enabled signal to the current vehicle, so that a dashboard end of the vehicle shows a vehicle behavior prompt in a synchronized manner. The vehicle behavior prompt includes changing a lane to pass a vehicle, avoiding an obstacle, avoiding pedestrians, slowing down to give way, and the like.

Operation 1105: Transmit traveling information of the current vehicle in real time.

For example, the current vehicle recognizes information about an obstacle such as a followed vehicle/pedestrian and information about a traffic light in real time through a device, such as a sensor and a camera, of the vehicle, and transmits a location and a distance of the obstacle such as the followed vehicle/pedestrian and a location and a distance of the traffic light to the server in real time.

Operation 1106: View the traveling information of the current vehicle in real time, and deliver a switch location identifier, a path guide identifier, and a navigation map panel if the current vehicle arrives at a first information prompt location.

For example, the server delivers, based on the location and the distance of the obstacle such as the followed vehicle/pedestrian and the location of the traffic light transmitted by the current vehicle, the switch location identifier to the vehicle-mounted map navigation system for drawing. In addition, the server calculates in real time whether a location of the current vehicle on a navigation route arrives at the first information prompt location. If the current vehicle arrives at the first information prompt location, the server delivers the switch location identifier, the path guide identifier, and the navigation map panel to the vehicle-mounted map navigation system for drawing to display.

Operation 1107: View the traveling information of the current vehicle in real time, and deliver a switch location identifier, a path guide identifier, a navigation map panel, and first prompt information if the current vehicle arrives at a second information prompt location.

For example, the server calculates in real time whether a location of the current vehicle on the navigation route arrives at the second information prompt location. If the current vehicle arrives at the second information prompt location, the server delivers the switch location identifier, the path guide identifier, and the navigation map panel to the vehicle-mounted map navigation system for drawing to display, and delivers the first prompt information. In some embodiments, the first prompt information includes at least one of displaying a flashing alert in the navigation interface or displaying a full-screen alert in the navigation interface, but is not limited thereto, which is not specifically limited in embodiments of the present disclosure.

Operation 1108: Provide a driver with a strong take-control prompt.

For example, the current vehicle provides the driver with the strong take-control prompt, for example, an alert sound, steering wheel vibration, or seatbelt tightening, but is not limited thereto, which is not specifically limited in embodiments of the present disclosure.

Operation 1109: Take control of the vehicle by turning a steering wheel or braking.

For example, after the driver takes control of the vehicle by turning the steering wheel or pressing a brake pedal, the current vehicle receives an action signal of the driver.

Operation 1110: Transmit an autonomous driving mode exit signal.

For example, the current vehicle transmits the autonomous driving mode exit signal to the server.

Operation 1111: Deliver all information about a manual driving mode to enable the vehicle-mounted map navigation system to switch to a manual driving state.

For example, the server delivers all information about the manual driving mode to enable the vehicle-mounted map navigation system to switch to the manual driving state.

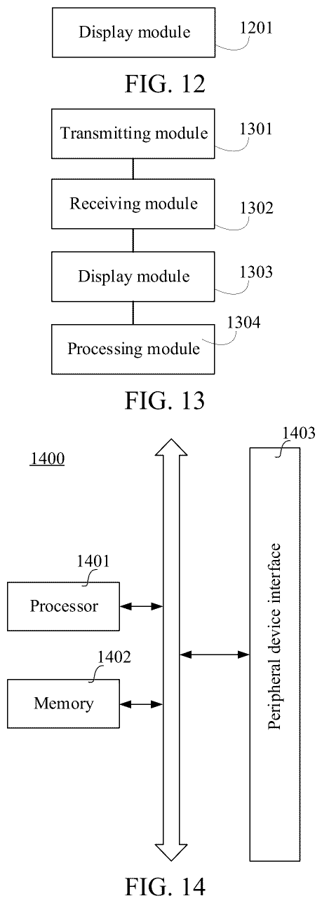

FIG. 12 is a schematic diagram of a structure of a navigation interface prompt apparatus according to an exemplary embodiment of the present disclosure. The apparatus may be implemented as all or a part of a computer device by software, hardware, or a combination of software and hardware. The apparatus includes:
a display module 1201, configured to display a dynamic location identifier corresponding to a vehicle in an electronic map in a navigation interface. The dynamic location identifier is configured for indicating a real-time location of the vehicle on a navigation route, and the current vehicle is in a first driving mode.

The display module 1201 is configured to display, at a pre-prompt stage before the vehicle exits the first driving mode, a switch location identifier on the navigation route. The switch location identifier is configured for indicating a predicted location at which the current vehicle exits the first driving mode and switches to a second driving mode.

In an embodiment, the display module 1201 is further configured to perform contents related to a display operation in the foregoing method embodiments in FIG. 3 and FIG. 4. For details, reference may be made to the foregoing method embodiments.

FIG. 13 is a schematic diagram of a structure of a navigation interface prompt apparatus according to an exemplary embodiment of the present disclosure. The apparatus may be implemented as all or a part of a computer device by software, hardware, or a combination of software and hardware. The apparatus includes:
a transmitting module 1301, configured to transmit traveling state information of a current vehicle to a server, the traveling state information including a driving mode of the current vehicle and road condition information;
a receiving module 1302, configured to receive a driving mode switch response transmitted, based on the traveling state information, by the server, the driving mode switch response being configured for indicating that the driving mode of the current vehicle switches from a first driving mode to a second driving mode; and
a display module 1303, configured to display a switch location identifier on a navigation route in a navigation interface of a vehicle-mounted map navigation system based on the driving mode switch response, the switch location identifier being configured for indicating a predicted location at which the current vehicle exits the first driving mode and switches to the second driving mode.

In an embodiment, the display module 1303 is further configured to perform contents related to a display operation in the foregoing method embodiments in FIG. 9 and FIG. 10. The receiving module 1302 is further configured to perform contents related to a receiving operation in the foregoing method embodiments in FIG. 9 and FIG. 10. For details, reference may be made to the foregoing method embodiments.

In an embodiment, the driving mode switch response is response information carrying time information. The apparatus further includes a processing module 1304. The processing module 1304 is configured to obtain a location of the switch location identifier on the navigation route based on the time information and in combination with a movement speed of the current vehicle.

In an embodiment, the driving mode switch response is response information carrying distance information. The processing module 1304 is further configured to obtain a location of the switch location identifier on the navigation route based on the distance information.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

FIG. 14 is a block diagram of a structure of a computer device 1400 according to an exemplary embodiment of the present disclosure. The computer device 1400 may be a portable mobile terminal, such as a smart phone, a tablet computer, a Moving Picture Experts Group Audio Layer III (MP3) player, or a Moving Picture Experts Group Audio Layer IV (MP4) player. The computer device 1400 may also be referred to as another name such as user equipment or a portable terminal.

Generally, the computer device 1400 includes a processor 1401 and a memory 1402.

The processor 1401 may include one or more processing cores, for example, a 4-core processor or an 8-core processor. The processor 1401 may be implemented in at least one hardware form of digital signal processing (DSP), a field programmable gate array (FPGA), or a programmable logic array (PLA). The processor 1401 may alternatively include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more computer-readable storage media. The computer-readable storage medium may be tangible and non-transitory. The memory 1402 may further include a high-speed random access memory and a non-volatile memory, for example, one or more disk storage devices or flash storage devices. In some embodiments, the non-transitory computer-readable storage medium in the memory 1402 is configured to store at least one instruction. The at least one instruction is configured for being executed by the processor 1401 to implement the navigation interface prompt method provided in embodiments of the present disclosure.

In some embodiments, the computer device 1400 may alternatively include a peripheral device interface 1403 and at least one peripheral device. Specifically, the peripheral device includes at least one of a radio frequency circuit, a touch display screen, a camera component, an audio circuit, or a power supply.

A person skilled in the art may understand that the structure shown in FIG. 14 does not constitute a limitation on the computer device 1400, and the computer device 1400 may include more or fewer components than those shown in the figure, or some components may be combined, or a different component deployment may be used.

An embodiment of the present disclosure further provides a computer device. The computer device includes a processor and a memory. The memory has at least one program stored therein. The at least one program is loaded and executed by the processor to implement the navigation interface prompt method according to the foregoing method embodiments or the method for indicating a driving mode change according to the foregoing method embodiments.

An embodiment of the present disclosure further provides a computer-readable storage medium. The storage medium has at least one computer program stored thereon. The at least one computer program is loaded and executed by a processor to implement the navigation interface prompt method according to the foregoing method embodiments or the method for indicating a driving mode change according to the foregoing method embodiments.

An embodiment of the present disclosure further provides a computer program product. The computer program product includes a computer program stored on a computer-readable storage medium. The computer program is read from the computer-readable storage medium and executed by a processor of a computer device, to enable the computer device to implement the navigation interface prompt method according to the foregoing method embodiments or the method for indicating a driving mode change according to the foregoing method embodiments.

The technical solutions provided in the present disclosure provide at least the following beneficial effects.

A dynamic location identifier corresponding to a vehicle is displayed in an electronic map in a navigation interface, and a switch location identifier is displayed on a navigation route at a pre-prompt stage before the vehicle exits a first driving mode. In the present disclosure, displaying a switch location identifier on a navigation route in a navigation interface allows a driver to clearly know driving mode switch time of a vehicle, so that dangers caused by unpredictable specific switch time of driving mode switch during traveling of the vehicle can be effectively avoid, thereby improving vehicle driving safety.

In the specific implementation of the present disclosure, relevant data such as user data processing related to user identities or features such as data, historical data, and profiles. When the foregoing embodiments of the present disclosure are applied to a specific product or technology, a permission or consent of a user is required. Collection, use and processing of relevant data need to comply with relevant laws, regulations and standards of relevant countries and regions.

What is claimed is:

1. A navigation interface prompt method, performed by a terminal, the method comprising:
displaying a dynamic location identifier corresponding to a vehicle in an electronic map in a navigation interface, the dynamic location identifier being configured for indicating a real-time location of the vehicle on a navigation route, and the vehicle being in a first driving mode; and
displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

2. The method according to claim 1, wherein displaying, at the pre-prompt stage before the vehicle exits the first driving mode, the switch location identifier on the navigation route in the navigation interface comprises:
displaying, at the pre-prompt stage before the vehicle exits the first driving mode, the switch location identifier on the navigation route, and displaying a path guide identifier and a navigation map panel in the navigation interface,
the path guide identifier being a guide identifier indicating that the dynamic location identifier, corresponding to the vehicle, moves to the switch location identifier.

3. The method according to claim 2, wherein displaying, at the pre-prompt stage before the vehicle exits the first driving mode, the switch location identifier on the navigation route, and displaying the path guide identifier and the navigation map panel in the navigation interface comprise:
displaying, at the pre-prompt stage before the vehicle exits the first driving mode, the switch location identifier on the navigation route in response to the dynamic location identifier arriving at a first information prompt location, and displaying the path guide identifier and the navigation map panel in the navigation interface,
the first information prompt location being a location that is from the switch location identifier by a first threshold on the navigation route.

4. The method according to claim 2, wherein displaying, at the pre-prompt stage before the vehicle exits the first driving mode, the switch location identifier on the navigation route, and displaying the path guide identifier and the navigation map panel in the navigation interface comprises:
displaying, at the pre-prompt stage before the vehicle exits the first driving mode, the switch location identifier on the navigation route in response to the dynamic location identifier arriving at a second information prompt location, displaying the path guide identifier and the navigation map panel in the navigation interface, and transmitting first prompt information,
the second information prompt location being a location that is from the switch location identifier by a second threshold on the navigation route.

5. The method according to claim 4, wherein the first prompt information comprises at least one of an alert sound, displaying of a flashing alert in the navigation interface, displaying of a full-screen alert in the navigation interface, steering wheel vibration, or seatbelt tightening.

6. The method according to claim 2, wherein the navigation map panel comprises information of at least one of a distance progress bar between the dynamic location identifier and the switch location identifier, numeric distance prompt information, or a navigation route thumbnail.

7. The method according to claim 1, further comprising:
displaying a corresponding first safety boundary identifier on the navigation route in response to a traveling state of the vehicle being a vehicle-following state, the first safety boundary identifier being configured for indicating a predicted location at which the vehicle keeps a safe driving distance from a preceding vehicle.

8. The method according to claim 1, further comprising:
displaying a corresponding second safety boundary identifier on the navigation route in response to a traveling state of the vehicle being an obstacle-avoiding state, the second safety boundary identifier being configured for indicating a predicted location at which the vehicle is to stop and keeps a safe driving distance from an obstacle.

9. The method according to claim 1, wherein
the first driving mode is an autonomous driving mode or an assisted driving mode, and the second driving mode is a manual driving mode;
the first driving mode is a fuel-powered driving mode or a fuel-gas-powered driving mode, and the second driving mode is an electric driving mode;
the first driving mode is a fuel-powered driving mode, and the second driving mode is a fuel-gas-powered driving mode; or
the first driving mode is a sport mode, and the second driving mode is a snow mode.

10. A computer device, comprising: one or more processors and a memory, the memory containing at least one computer program that, when being executed, causes the one or more processors to perform operations comprising:
displaying a dynamic location identifier corresponding to a vehicle in an electronic map in a navigation interface, the dynamic location identifier being configured for indicating a real-time location of the vehicle on a navigation route, and the vehicle being in a first driving mode; and
displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

11. The device according to claim 10, wherein the one or more processors are further configured to perform:
displaying, at the pre-prompt stage before the vehicle exits the first driving mode, the switch location identifier on the navigation route, and displaying a path guide identifier and a navigation map panel in the navigation interface,
the path guide identifier being a guide identifier indicating that the dynamic location identifier, corresponding to the vehicle, moves to the switch location identifier.

12. The device according to claim 11, wherein the one or more processors are further configured to perform:
displaying, at the pre-prompt stage before the vehicle exits the first driving mode, the switch location identifier on the navigation route in response to the dynamic location identifier arriving at a first information prompt location, and displaying the path guide identifier and the navigation map panel in the navigation interface,
the first information prompt location being a location that is from the switch location identifier by a first threshold on the navigation route.

13. The device according to claim 11, wherein the one or more processors are further configured to perform:
displaying, at the pre-prompt stage before the vehicle exits the first driving mode, the switch location identifier on the navigation route in response to the dynamic location identifier arriving at a second information prompt location, displaying the path guide identifier and the navigation map panel in the navigation interface, and transmitting first prompt information,
the second information prompt location being a location that is from the switch location identifier by a second threshold on the navigation route.

14. The device according to claim 13, wherein the first prompt information comprises at least one of an alert sound, displaying of a flashing alert in the navigation interface, displaying of a full-screen alert in the navigation interface, steering wheel vibration, or seatbelt tightening.

15. The device according to claim 11, wherein the navigation map panel comprises information of at least one of a distance progress bar between the dynamic location identifier and the switch location identifier, numeric distance prompt information, or a navigation route thumbnail.

16. The device according to claim 10, wherein the one or more processors are further configured to perform:
displaying a corresponding first safety boundary identifier on the navigation route in response to a traveling state of the vehicle being a vehicle-following state, the first safety boundary identifier being configured for indicating a predicted location at which the vehicle keeps a safe driving distance from a preceding vehicle.

17. The device according to claim 10, wherein the one or more processors are further configured to perform:
displaying a corresponding second safety boundary identifier on the navigation route in response to a traveling state of the vehicle being an obstacle-avoiding state, the second safety boundary identifier being configured for indicating a predicted location at which the vehicle is to stop and keeps a safe driving distance from an obstacle.

18. The device according to claim 10, wherein
the first driving mode is an autonomous driving mode or an assisted driving mode, and the second driving mode is a manual driving mode;
the first driving mode is a fuel-powered driving mode or a fuel-gas-powered driving mode, and the second driving mode is an electric driving mode;
the first driving mode is a fuel-powered driving mode, and the second driving mode is a fuel-gas-powered driving mode; or
the first driving mode is a sport mode, and the second driving mode is a snow mode.

19. A non-transitory computer-readable storage medium storing a computer-executable instruction that, when being executed, causes one or more processors to perform an information processing method, the method comprising:
displaying a dynamic location identifier corresponding to a vehicle in an electronic map in a navigation interface, the dynamic location identifier being configured for indicating a real-time location of the vehicle on a navigation route, and the vehicle being in a first driving mode; and
displaying, at a pre-prompt stage before the vehicle exits the first driving mode, a switch location identifier on the navigation route in the navigation interface, the switch location identifier being configured for indicating a predicted location at which the vehicle exits the first driving mode and switches to a second driving mode.

20. The storage medium according to claim 19, wherein the one or more processors are further configured to perform:
displaying, at the pre-prompt stage before the vehicle exits the first driving mode, the switch location identifier on the navigation route, and displaying a path guide identifier and a navigation map panel in the navigation interface,
the path guide identifier being a guide identifier indicating that the dynamic location identifier, corresponding to the vehicle, moves to the switch location identifier.
